(19) United States
(12) Patent Application Publication
(10) Pub. No.: US 2003/0053634 A1
(43) Pub. Date: Mar. 20, 2003

(54) Virtual audio environment

(75) Inventors: David Stanley McGrath, Ultimo (AU); Leonard Layton, Ultimo (AU)

Correspondence Address: FULWIDER PATTON LEE & UTECHT, LLP, 200 OCEANGATE, SUITE 1550, LONG BEACH, CA, 90802, US

(73) Assignee: Lake Technology Limited

(21) Appl. No.: 10/219,232

(22) Filed: Aug. 15, 2002

Related U.S. Application Data
(63) Continuation of application No. PCT/AU01/00162, filed on Feb. 16, 2001.

(30) Foreign Application Priority Data
Feb. 17, 2000 (AU) PQ 5707

(51) Int. Cl. H04R 5/00; H04R 5/02

(52) U.S. Cl. 381/26; 381/1; 381/310

(57) ABSTRACT

An audio system for providing an immersive audio experience, said system comprising: a recording system including a system for recording spatialised audio information at an event location; a broadcasting system for broadcasting said spatialised audio information to multiple users located away from said event location; and a plurality of rendering systems for rendering said broadcast spatialised audio information in a manner so as to create an apparent event location audio environment around each listener, wherein said spatialisation is maintained in the presence of movement of a listener's head.

### FIELD OF THE INVENTION

The present invention relates to the field of Audio Signal Processing, and, in particular, discloses an immersive audio application having novel operational characteristics.

### BACKGROUND OF THE INVENTION

It is well known to provide a system for remote viewing of events such as sporting contests or alike. Systems presently available include radio broadcasts and television broadcasts of events. Television broadcasts normally consists of a video and audio track with the video track taken from a camera and the audio track taken from microphones placed around the event. Different forms of broadcasting such events are possible. For example, recently, Internet streaming has become a popular form of broadcast format. Further, compressed forms of broadcast transmission are becoming popular especially with digital compression and decompression technologies. For example MPEG video is often a very popular form of video compression technology.

It will be desirable if a more immersive form of broadcast of an event was possible.

### SUMMARY OF THE INVENTION

In accordance with a first aspect of the present invention, there is provided an audio system for providing an immersive audio experience, said system comprising:

a recording system including a system for recording spatialised audio information at an event location;

a broadcasting system for broadcasting said spatialised audio information to multiple users located away from said event location; and

a plurality of rendering systems for rendering said broadcast spatialised audio information in a manner so as to create an apparent event location audio environment around each listener, wherein said spatialisation is maintained in the presence of movement of a listener's head.

Preferably, said system further comprises:

a plurality of audio feedback units for providing audio feedback to said broadcasting system each audio feedback unit associated, in use, with one of said listeners, and

means for forwarding audio feedback from a first one of said audio feedback units to other ones for rendering by said rendering system.

In one embodiment, said rendering units are adapted, in use, to render said audio feedback in a spatialised manner.

Said broadcasting system may be adapted, in use, to forward said audio feedback to said sporting event for playback at said sporting event.

Preferably, said recording system records video information associated with events occurring contemporaneously with the recording of said spatialised audio information at said event location and said rendering system is adapted, in use, to render said video information to said listeners.

In one embodiment said system is utilised to broadcast an immersive audio experience associated with a sporting event.

Said system may be adapted, in use, such that multiple different spatialised audio tracks are recorded and mixed together to form said spatialised audio information.

Preferably, said audio tracks include a commentary of said immersive audio experience.

In one embodiment, said broadcasting comprises one of radio transmission, cable transmission or Internet Streaming.

Said spatialised audio information may comprise B-format audio information.

Preferably, said spatialised audio information comprises a spatialisation of AC-3 encoded audio information.

In accordance with a second aspect of the present invention, there is provided a method of creating an immersive audio experience comprising the steps of:

(a) recording spatialised audio information at an event location;

(b) broadcasting the recording to a series of listeners located away from said event location; and

(c) rendering the spatialised audio information to said listeners in a spatialised manner so as to create an apparent event location audio environment around said listeners and

(d) maintaining said spatialisation in the presence of movement of a listener's head.

Preferably, the method further comprises the steps of:

(e) recording a listener audio input from one of said listeners;

(f) broadcasting the listener audio input to other listeners, and;

(g) rendering the listener audio input to said other listeners in conjunction with said spatialised audio information.

The method may further comprise the step of:

(h) forwarding predetermined listener audio inputs to the event location for playback over an event audio system located at the event location.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates an example output environment of the preferred embodiment;

FIG. 2 illustrates a schematic block diagram of the operational portions of an embodiment;

FIG. 3 illustrates a schematic block diagram of an alternative embodiment; and

FIG. 4 illustrates schematically the client unit of FIG. 3 in more detail.

### DETAILED DESCRIPTION OF THE EMBODIMENTS

In the preferred embodiment, there is provided an audio visual immersive system having sound spatalization characteristics which provides for an enhanced audio experience.

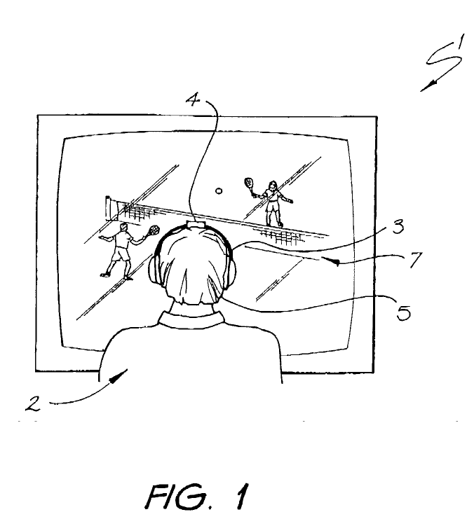

Turning to FIG. 1, there is illustrated an initial example viewing arrangement 1 of the preferred embodiment wherein a listener 2 wears a pair of head tracked headphones 3 which include a head tracking unit 4 which tracks the current orientation of the headphones 3 and, in turn, the listener's head 5. The listener views a sporting event 7 on a monitor whilst listening to an audio track via the headphones 3. The audio track provides spatialization of the listening environment such that audio sources appear to be spatalized around a listener at pre-determined locations. The spatalization is such that the spatalization remains substantially constant within the reference frame of the monitor 7 when the listener 2 rotates their head 5 (i.e. the spatial location of sound sources to the listener remains constant as the listener rotates their head).

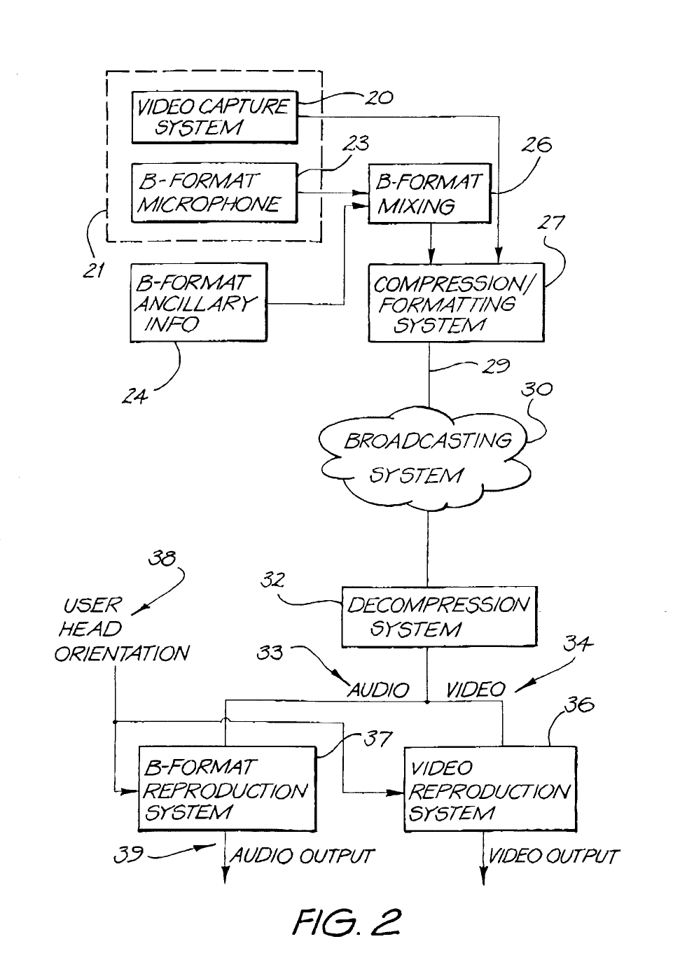

Turning to FIG. 2, there is a schematic block diagram of one form of system suitable for implementation of the preferred embodiment. In this system, there is firstly provided, at a sporting event or the like, a video capture system 20 for capturing at least one video representation of the event. The video capture may be mixed or that taken from a single camera. Further, depending on the encoding system utilised, multiple video representations can be independently captured.

Also at the event 21 is one or more B-format microphones 23. The B-format microphones are able to capture a three dimensional representation of the spatialization of an audio environment. The B-format microphone, can, for example, be strategically spaced in an ideal viewing area at the event. Additionally, other audio information can also be provided 24 in a B-format output signal. This allows for the characterisation of audio sources at particular locations around a listener. For example, a commentary of the occurrence of events at the sporting event can be provided with the commentator being located quite close to the shoulder of the listener/viewer of the event. Systems for rendering audio signals to particular locations in B-format are known. The B-format signals are mixed together 26. The mixing can be a quite simple addition of the B-format components. Alternatively, more complex mixing schemes could be utilised. The audio output in addition to the video output is forward to a compression or formatting system 27 which compresses the streams of information into a compressed format. Obviously, other forms of streams can be simultaneously compressed as part of the output signal and, for example, multiple B-format signals and other associated audio tracks in addition to other video signals and associated visual information such as players statistics could also be compressed into the output compressed format.

The output of the compression formatting system 27 is forwarded 29 to a broadcasting system 30. The broadcasting system could comprise, for example, an Internet type streaming environment or form alternative more standard forms of broadcasting such as those utilised in the broadcasting of television such as radio signals, satellite transmission, cable transmission etc. The broadcast can be from a single broadcasting station to multiple users.

Each user in receipt of the signal includes a decompression system 32 which decompresses the compressed video and audio streams to produce audio B-format output 33 and video output 34. The video output 34 is forwarded to a video reproduction system 36 where it is conditioned become video output on the screen display 7 (FIG. 1). The audio output stream is forwarded to a B-format reproduction system 37 which takes, as part of its input, a current user head orientation 38 and produces audio output 39 so as to maintain a substantially constant spatalization of audio B-format in the presence of head movements of a listener. The B-format reproduction system can be constructed substantially in accordance with the system disclosed in the United States Patent No.6021206 entitled “Method and Apparatus for processing spatalized audio”, the contents of which are specifically incorporated by cross reference. The system disclosed in the aforementioned patent specification allows for spatalization of B-format audio in the presence of head movements of a listener.

Hence, the arrangement of the preferred embodiment provides for an immersive audio environment such that the user is placed in one of the “best seats in the house” and provided with a fully immersive audio environment.

Many further modifications are possible to preferred embodiment. For example, multiple users can be accommodated with substantial reuse of components through the utilisation of multiple B-format reproduction system units 37 with each user having an independent user head orientation. Obviously, only one B-format signal need be broadcast so as to cater for multiple independent listeners.

Further, other encoding arrangements can be provided. For example, where a 5 channel Dolby AC-3 surround environment audio signal is provided, a speaker encoding can be provided transferring the encoding format from say a Dolby AC-3 format to a B-format. The surround encoding can also provide for three dimensional characteristics through the height positioning of sound sources in an AC-3 environment or the adoption of more complex environments. Further, more complex formats of video signals could be provided. For example, a spherical ball type arrangement (or its digital equivalent) could be provided so that a user utilising a pair of goggles can be provided with an even more immersive experience such that the user's head orientation 38 is also utilised in the video reproduction system 39 to show a “field of view” of a current listener's likely viewing orientation. Hence, as the listener rotates the head, the image displayed 7 can also be rotated so as to also be in sync with the audio rotation.

The preferred embodiment obvious has many other uses. For example, it provides for an enhanced telepresence experience through the increased immersive characteristics through the utilisation of B-format information. Further, it could be extended to other arrangements such as placing the video capture system and B-format microphone on top of a mobile robot or the like so as to provide for a high level of telepresence. This will have advantageous operational characteristics in harmful or extreme environments or the like so as to provide for enhanced telepresence capabilities.

The system described can be further extended to provide multi-user feedback. For example, one of the joys of going to a sporting ground and watching an event, is ‘debating’ the on-field action with fellow spectators and friends. Another example of a feedback situation is where people often get together to watch a sporting event at one person's home—for example a football match being played overseas.

The present invention can be extended to simulate such arrangements so as to provide a communications system that allows people to communicate with others that are watching the same event.

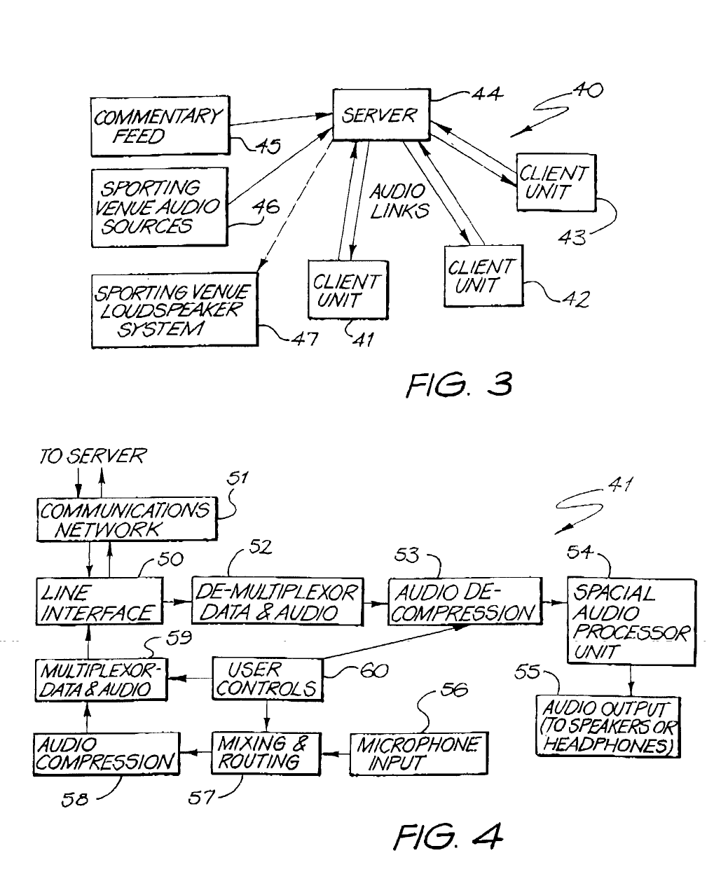

Turning to FIG. 3, there is illustrated schematically an example system 40 suitable for implementing a feedback type environment. The system includes a number of client units 41-43. Each client unit is responsible for rending audio sources received from a server 44 in addition to forwarding a microphone input to the server 44. The server 44 in turn takes a number of audio feeds from the sporting event. These can include a commentary feed 45, various B format sporting venue audio sources 46. Additionally, the system can provide for a form of client unit user feedback through a loud speaker system 47 located at the sporting event which provides for a form of microphone output of the home users comments.

The server is responsible for forwarding the audio streams to the client units and can include means for streaming audio feedbacks from various client units to other client units in accordance with user set ups.

Turning to FIG. 4, there is illustrated in schematic block form one example client unit arrangement 41. The arrangement of the client unit 41 can include a line interface 50 which interfaces with a communications network 51 to the server. The communication can be of a standard internet type streaming environment. The audio visual data received from the server including the various audio streams is demultiplexed 52 before being decompressed 53. The decompressed streams are then forwarded to the spatialisation unit 54 which combines the streams in accordance with requirements and spatialised them so as to provide audio outputs 55 which can be fed to headphones placed around the listener.

Where provided, a microphone input 56 is fed to a mixing and routing unit 57 which digitises the input. Subsequently, it is compressed 58 before being multiplexed with other data 59 and output via line interface 50 to the server. A series of user controls 60 are also provided for controlling the overall arrangement 41 so as to provide for a variable spatialisation experience.

As multiple client units are able to interact, the system allows people to communicate with others watching the same event so as to experience a combined immersive experience.

Obviously further modifications can be made, for example, rather than headphone arrangements, a user's home theatre system could be utilised for spatializing the playback. Further, various controls could be provided for selective communication and selective experiences whereby users only communicate with other people from a nominated group or from the ground itself etc.

Further, the system could allow various sounds such as cheering or applause from people listening to the client units to be relayed to the sporting venue and played over the sporting venues loud speaker system.

It would be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

It will be understood that the invention disclosed and defined herein extends to all alternative combinations of two or more of the individual features mentioned or evident from the text or drawings. All of these different combinations constitute various alternative aspects of the invention.

What is claimed is:

1. An audio system for providing an immersive audio experience, said system comprising:
a recording system including a system for recording spatialised audio information at an event location;
a broadcasting system for broadcasting said spatialised audio information to multiple users located away from said event location; and
a plurality of rendering systems for rendering said broadcast spatialised audio information in a manner so as to create an apparent event location audio environment around each listener, wherein said spatialisation is maintained in the presence of movement of a listener's head.

2. A system as claimed in claim 1 wherein said system further comprises:
a plurality of audio feedback units for providing audio feedback to said broadcasting system each audio feedback unit associated, in use, with one of said listeners, and
means for forwarding audio feedback from a first one of said audio feedback units to other ones for rendering by said rendering system.

3. A system as claimed in claim 2 wherein said rendering units are adapted, in use, to render said audio feedback in a spatialised manner.

4. A system as claimed in claim 2 wherein said broadcasting system is adapted, in use, to forward said audio feedback to said sporting event for playback at said sporting event.

5. A system as claimed in claim 1 wherein said recording system records video information associated with events occurring contemporaneously with the recording of said spatialised audio information at said event location and said rendering system is adapted, in use, to render said video information to said listeners.

6. A system as claimed in claim 1 wherein said system is utilised to broadcast an immersive audio experience associated with a sporting event.

7. A system as claimed in claim 1 wherein said system is adapted, in use, such that multiple different spatialised audio tracks are recorded and mixed together to form said spatialised audio information.

8. A system as claimed in claim 7 wherein said audio tracks include a commentary of said immersive audio experience.

9. A system as claimed in claim 1 wherein said broadcasting comprises one of radio transmission, cable transmission or Internet Streaming.

10. A system as claimed in claim 1 wherein said spatialised audio information comprises B-format audio information.

11. A system as claimed in claim 1 wherein said spatialised audio information comprises a spatialisation of AC-3 encoded audio information.

12. A method of creating an immersive audio experience comprising the steps of:
(a) recording spatialised audio information at an event location;
(b) broadcasting the recording to a series of listeners located away from said event location; and
(c) rendering the spatialised audio information to said listeners in a spatialised manner so as to create an apparent event location audio environment around said listeners and
(d) maintaining said spatialisation in the presence of movement of a listener's head.

13. A method as claimed in claim 12 further comprising the steps of:
(e) recording a listener audio input from one of said listeners;
(f) broadcasting the listener audio input to other listeners, and;
(g) rendering the listener audio input to said other listeners in conjunction with said spatialised audio information.

14. A method as claimed in claim 13 further comprising the step of:
(h) forwarding predetermined listener audio inputs to the event location for playback over an event audio system located at the event location.
